(19) United States
(12) Patent Application Publication
(10) Pub. No.: US 2013/0049388 A1
(43) Pub. Date: Feb. 28, 2013

(54) Bezels For Vehicle Accessory Assemblies And Vehicle Accessory Assemblies Comprising The Same

(71) Applicants: Jan-Michael Francis Stachura, Milan, MI (US); Toshinao Wada, Ann Arbor, MI (US)

(72) Inventors: Jan-Michael Francis Stachura, Milan, MI (US); Toshinao Wada, Ann Arbor, MI (US)

(73) Assignee: Toyota Motor Engineering & Manufacturing North America, Inc., Erlanger, KY (US)

(21) Appl. No.: 13/271,601

(22) Filed: Oct. 12, 2011

Related U.S. Application Data
(60) Provisional application No. 61/526,087, filed on Aug. 22, 2011.

(51) Int. Cl. B60R 11/00; B23P 11/00

(52) U.S. Cl. 296/1.07; 29/428

(57) ABSTRACT

A bezel for a vehicle accessory assembly includes a body portion, a perimeter wall extending from an underside of the body portion, an upper engagement portion extending in an inboard direction from an inboard side of the perimeter wall, and a snap portion coupled to the upper engagement portion. The snap portion includes a receiving slot for receiving a corresponding tab. The bezel further includes a lead-in portion extending from the snap portion in an inboard direction such that the lead-in portion is non-coplanar with the snap portion.

### CLAIM OF PRIORITY

This application claims the benefit of U.S. Provisional Application No. 61/526,087, entitled “Bezels for Vehicle Accessory Assemblies and Vehicle Accessory Assemblies Comprising the Same,” filed Aug. 22, 2011, the entirety of which is hereby incorporated by reference. This application is related to U.S. patent application Ser. No. ______, filed and entitled “Accessory Assemblies For Vehicles.”

### TECHNICAL FIELD

Embodiments provided herein generally relate to bezels for vehicle accessory assemblies, and more specifically, to bezels for vehicle accessory assemblies comprising a lead-in portion.

### BACKGROUND

Vehicles may contain accessory assemblies. A vehicle accessory assembly (e.g., a console, an instrument panel, or the like) may comprise an accessory, such as a receptacle (e.g., a cup holder), a trim panel (e.g., a bezel), and support panels (e.g., console side panels). The alignment of vehicle accessory assembly components during assembly of the components may be important to obtain a desired fit and finish. Existing vehicle accessory assemblies may allow vehicle accessory assembly components to be improperly assembled, which may result in an undesirable fit and finish. This requires additional vehicle accessory assembly inspections and corrections to improperly assembled vehicle accessory assemblies, both of which lead to increased manufacturing costs.

Accordingly, a need exists for alternative accessory assemblies for vehicles.

### SUMMARY

In one embodiment, a bezel for a vehicle accessory assembly includes a body portion, a perimeter wall extending from an underside of the body portion, an upper engagement portion extending in an inboard direction from an inboard side of the perimeter wall, and a snap portion coupled to the upper engagement portion. The snap portion includes a receiving slot for receiving a corresponding tab. The bezel further includes a lead-in portion extending from the snap portion in an inboard direction such that the lead-in portion is non-coplanar with the snap portion.

In another embodiment, a vehicle accessory assembly includes a bezel and a housing. The bezel includes a body portion, a perimeter wall extending from an underside of the body portion, an upper engagement portion extending in an inboard direction from an inboard side of the perimeter wall, and a snap portion coupled to the upper engagement portion. The snap portion includes a receiving slot for receiving a corresponding tab. The bezel further includes a lead-in portion extending from the snap portion in an inboard direction such that the lead-in portion is non-coplanar with the snap portion. The housing includes a side panel having at least one tab extending from a top of the side panel. As the bezel is installed on the housing, the tab of the side panel engages the lead-in portion of the bezel such that the lead-in portion of the bezel guides the tab over an outboard side of the snap portion and into engagement with the receiving slot of the bezel.

In yet another embodiment, a method of assembling a vehicle accessory assembly includes providing a bezel. The bezel includes a body portion, a perimeter wall extending from an underside of the body portion, an upper engagement portion extending in an inboard direction from an inboard side of the perimeter wall, and a snap portion coupled to the upper engagement portion. The snap portion includes a receiving slot for receiving a corresponding tab. The bezel further includes a lead-in portion extending from the snap portion in an inboard direction such that the lead-in portion is non-coplanar with the snap portion. The method further includes providing a housing. The housing includes a side panel having at least one tab extending from a top of the side panel. The method further includes positioning the bezel over the housing, engaging the tab of the side panel with the lead-in portion of the bezel, and applying force to the bezel to engage the tab of the side panel with the lead-in portion of the bezel such that the lead-in portion of the bezel guides the tab over an outboard side of the snap portion and into engagement with the receiving slot of the bezel, thereby attaching the bezel to the housing.

### BRIEF DESCRIPTION OF THE DRAWINGS

FIG. 1 schematically depicts a partial cross section of a conventional bezel and a side panel comprising a tab when the conventional bezel is in a pre-assembly position with respect to the side panel;

FIG. 2 schematically depicts a partial cross section of a conventional bezel and a side panel comprising a tab when the conventional bezel and the side panel are improperly assembled;

FIG. 3 schematically depicts a perspective view of a vehicle accessory assembly comprising a bezel installed on side panels of a housing, according to one or more embodiments shown and described herein;

FIG. 4 schematically depicts a perspective view of a bezel comprising a snap, according to one or more embodiments shown and described herein;

FIG. 5 schematically depicts a partial cross section of the bezel of FIG. 4, according to one or more embodiments shown and described herein;

FIG. 6 schematically depicts a perspective view of a side panel of a housing comprising a tab extending from the top of the side panel, according to one or more embodiments shown and described herein;

FIG. 7 schematically depicts a partial cross section of a bezel comprising a snap portion and a lead-in portion and a side panel comprising a tab, when the bezel is in a pre-assembly position with respect to the side panel, according to one or more embodiments shown and described herein; and

FIG. 8 schematically depicts a partial cross section of a bezel comprising a snap portion and a lead-in portion and a side panel comprising a tab, when the bezel and the side panel are assembled, according to one or more embodiments shown and described herein.

### DETAILED DESCRIPTION OF THE DRAWINGS

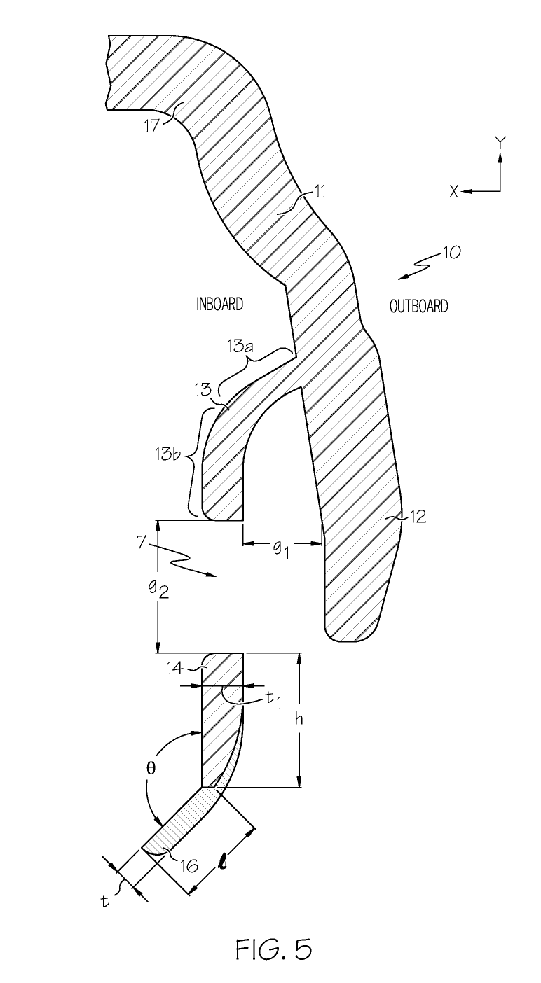

FIG. 5 generally depicts a partial cross section of a bezel comprising a snap with a lead-in portion for preventing misalignment of the bezel with a corresponding housing. The bezel generally comprises a body portion, a perimeter wall, an upper engagement portion, a snap portion, and a lead-in portion. The perimeter wall extends from an underside of the body portion. The upper engagement portion extends in an inboard direction from an inboard side of the perimeter wall. The snap portion is coupled to the upper engagement portion. The snap portion includes a receiving slot for receiving a corresponding tab. The lead-in portion extends from the snap portion in an inboard direction such that the lead-in portion is non-coplanar with the snap portion. As the bezel is installed on a side panel, a tab of the side panel engages the lead-in portion of the bezel such that the lead-in portion guides the tab over an outboard side of the snap portion and into engagement with the receiving slot of the bezel. Bezels, vehicle accessory assemblies comprising a bezel, and methods for assembling the same will be described in more detail herein with specific reference to the corresponding drawings.

Coordinate axes are included in the drawings in order to provide a frame of reference for various components of the bezels and vehicle accessory assemblies. As used herein, “above” is defined as the positive y direction of the coordinate axes shown in the drawings. “Below” is defined as the negative y direction of the coordinate axes shown in the drawings. “Inboard” is defined as the positive x direction of the coordinate axes shown in the drawings. “Outboard” is defined as the negative x direction of the coordinate axes shown in the drawings. “Forward” is defined as the positive z direction of the coordinate axes shown in the drawings. “Rear” is defined as the negative z direction of the coordinate axes shown in the drawings.

Vehicle accessory assemblies (e.g., consoles, instrument panels, or the like) may comprise an accessory, such as a receptacle (e.g., a cup holder), a trim panel (e.g., a bezel), and support panels (e.g., console side panels). Such vehicle accessory assemblies may be assembled by snapping together the components of the vehicle accessory assembly. While the embodiments described herein are described in reference to vehicle consoles comprising a bezel and console side panels, embodiments are not limited thereto. For example, in some embodiments, a vehicle accessory assembly may comprise a trim panel other than a bezel. In other embodiments, a vehicle accessory assembly may comprise support panels other than console side panels.

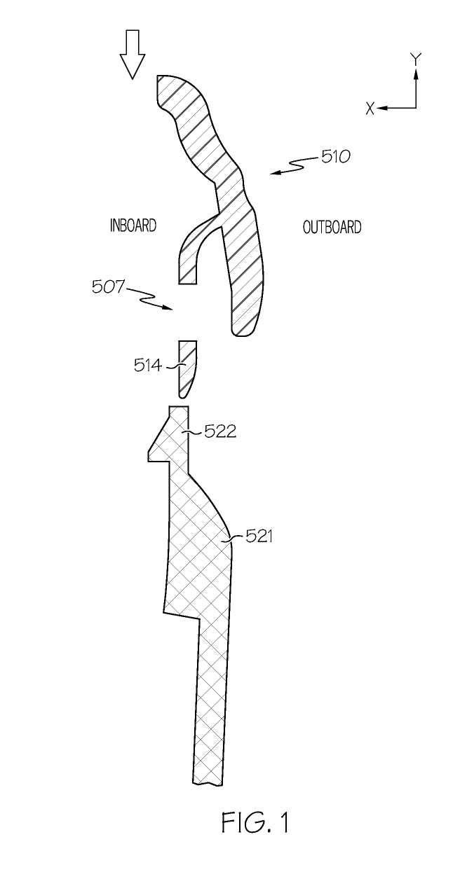

Referring now to FIG. 1, a partial cross section of a conventional bezel 510 and a side panel 521 comprising a tab 522 when the conventional bezel 510 is in a pre-assembly position with respect to the side panel 521 is schematically depicted. As illustrated in FIG. 1, the conventional bezel 510 comprises a receiving slot 507 and a snap portion 514. The side panel 521 contains a tab 522 extending from the top of the side panel 521. In a pre-assembly position, the tab 522 of the side panel 521 is positioned beneath the snap portion 514 of the conventional bezel 510.

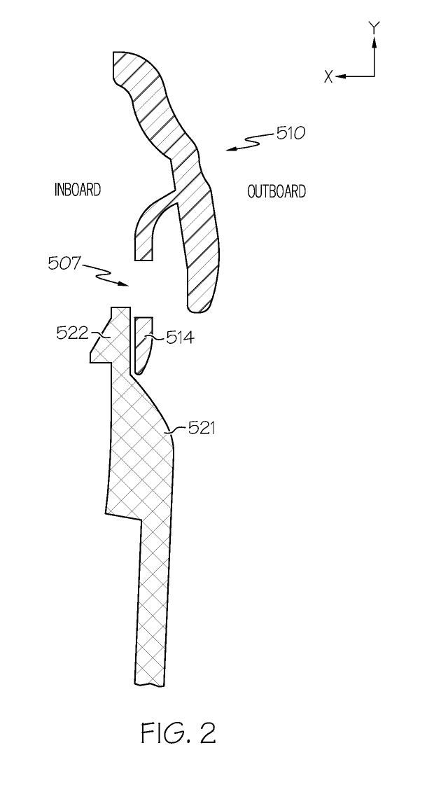

In order to assemble the conventional bezel 510 and the side panel 521, the conventional bezel 510 is lowered onto the side panel 521 such that the tab 522 of the side panel 521 engages the bottom of the snap portion 514. Due to material characteristics and/or manufacturing tolerances, the side panel 521 may be pushed to the inboard side of the snap portion 514 as the conventional bezel 510 and the side panel 521 are assembled together. This may result in the conventional bezel 510 and the side panel 521 being assembled incorrectly and with improper alignment, as depicted in FIG. 2. The embodiments described herein are directed to bezels and vehicle accessory assemblies comprising bezels that mitigate the misalignment condition depicted in FIG. 2.

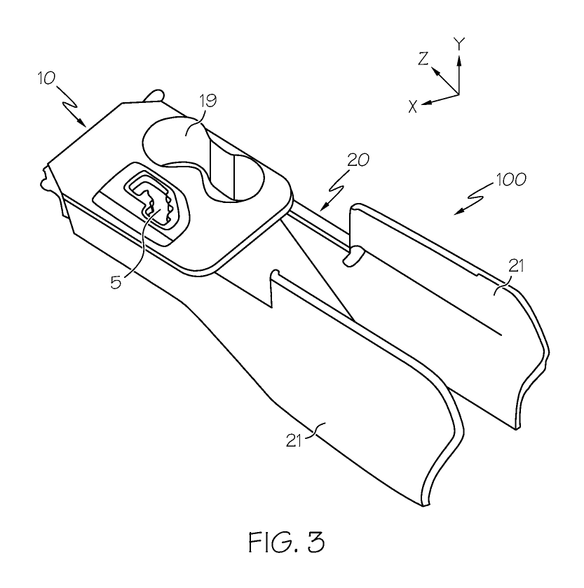

Referring now to FIG. 3, a perspective view of a vehicle accessory assembly 100 comprising a bezel 10 installed on side panels 21 of a housing 20 is schematically depicted. While the vehicle accessory assembly 100 is schematically depicted in FIG. 3 as a vehicle console, other embodiments include vehicle accessory assemblies other than vehicle consoles, such as, for example, instrument panels, instrument clusters, or the like.

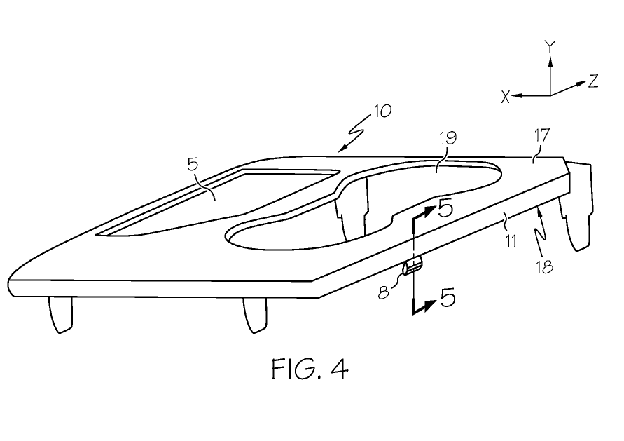

Referring now to FIGS. 3 and 4, the bezel 10 of the vehicle accessory assembly 100 comprises a snap 8 is schematically depicted. The bezel 10 comprises a gear shift opening 5 for allowing a gear shift to protrude through the gear shift opening 5. In other embodiments, the bezel 10 is constructed without the gear shift opening 5. The bezel 10 further comprises an accessory opening 19 for receiving a corresponding vehicle accessory. The vehicle accessory received by accessory opening 19 may be a receptacle, e.g., one or more cup holders. The bezel 10 further comprises a body portion 17 and a perimeter wall 11 extending from an underside 18 of the body portion 17.

Referring now to FIG. 5, a partial cross section of the bezel 10 of FIG. 4 is schematically depicted. As noted hereinabove, the bezel 10 generally comprises a body portion 17, a perimeter wall 11, an overhang portion 12, an upper engagement portion 13, a snap portion 14, and a lead-in portion 16. The perimeter wall 11 extends from an underside 18 of the body portion 17. The overhang portion 12 extends from the perimeter wall 11 in a direction substantially parallel to the perimeter wall 11. While the bezel 10 is depicted as comprising the overhang portion 12 in FIG. 5, in some embodiments, the bezel 10 may be constructed without the overhang portion 12.

Still referring to FIG. 5, the upper engagement portion 13 receives a corresponding tab 22 of a side panel 21 in order to secure the side panel 21 and the bezel 10 to one another. The upper engagement portion 13 extends in an inboard direction from an inboard side of the perimeter wall 11. The upper engagement portion 13 comprises an upper part 13a and a lower part 13b. The upper part 13a of the upper engagement portion 13 extends from the inboard side of the perimeter wall 11 in an inboard direction, which, in some embodiments, may be substantially perpendicular to the perimeter wall 11. The lower part 13b extends from the upper part 13a in a direction substantially parallel to the perimeter wall 11. While the upper engagement portion 13 depicted in FIG. 5 has a generally arcuate cross section, in other embodiments, the upper part 13a and the lower part 13b of the upper engagement portion 13 may be substantially straight. The lower part 13b of the upper engagement portion 13 is spaced apart from the overhang portion 12 by a gap g₁ to accommodate accepting a tab of a side panel (not shown). In some embodiments, the maximum distance of the gap g₁ between the lower part 13b of the upper engagement portion 13 and the overhang portion 12 is about 2.6 millimeters. However, it should be understood that the gap g₁ may have other dimensions.

Still referring to FIG. 5, at least a part of the snap portion 14 is spaced apart from the upper engagement portion 13 by a receiving slot 7 for receiving a corresponding tab of a side panel. The width g₂ of the receiving slot 7 is about 5 mm, however it should be understood that the width g₂ of the receiving slot 7 may have other dimensions. A height h of the snap portion 14 is about 5 mm, however, it should be understood that the height h may have other dimensions. In some embodiments, a thickness t₁ of the snap portion 14 is about 1.5 mm, however, it should be understood that the thickness t₁ of the snap portion 14 may have other dimensions.

Still referring to FIG. 5, the lead-in portion 16 extends form the snap portion 14 in an inboard direction such that the lead-in portion 16 is non-coplanar with the snap portion 14. The lead-in portion 16 is oriented such that the lead-in portion 16 extends at an angle θ relative to the snap portion 14. In some embodiments, the angle θ is about 135°. In other embodiments, the angle θ satisfies the relation 125°≦θ≦145°. However, it should be understood that other angles θ may also be possible. In the embodiment depicted in FIG. 5, a thickness t₂ of the lead-in portion 16 is about 1.5 mm. However, in other embodiments, the thickness t₂ may have other dimensions depending on the specific application. In some embodiments, the cross-sectional thickness of the snap portion 14 is about the same as the cross-sectional thickness of the lead-in portion 16. In the embodiment depicted in FIG. 5, a length l of the snap lead-in is about 3.2 mm. However, in other embodiments, the length l may have other dimensions depending on the specific application. In some embodiments, the lead-in portion 16 has a substantially straight cross-section, while, in other embodiments, the lead-in portion 16 has an arcuate cross-section.

The bezel 10 is formed from a first material. The first material may comprise metal, plastic, or composite materials. In the embodiments shown and described herein, the bezel 10 is formed by injection molding acrylonitrile butadiene styrene (“ABS”) or a polycarbonate material. However, it should be understood that other materials and other forming processes can be used to construct the bezel 10. In some embodiments, the bezel 10 is formed as a unitary piece, while, in other embodiments, the bezel 10 comprises multiple pieces.

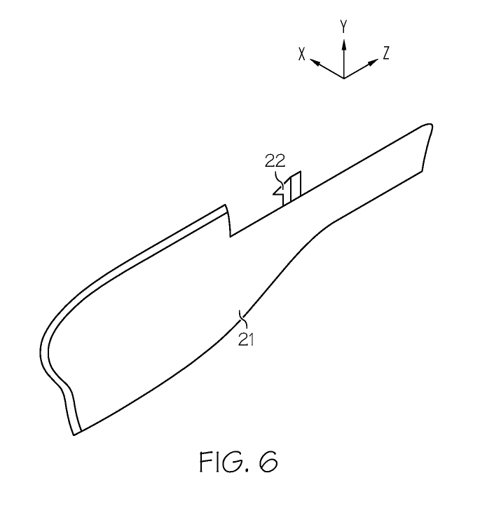

Referring now to FIG. 6, a perspective view of a side panel 21 of a housing is schematically depicted. A tab 22 extends from the top of the side panel 21. The tab 22 facilitates securing the side panel 21 and the bezel 10 to one another. Specifically, as the bezel 10 of FIG. 3 is installed on the housing 20 of FIG. 3, the tab 22 of the side panel 21, depicted in FIG. 6, engages the corresponding receiving slot in the bezel 10. While the side panel 21 is schematically depicted as including only one tab 22 extending from the top of the side panel 21, multiple tabs may extend from the top of the side panel 21. Each tab extending from the top of side panel 21 may correspond to a matching receiving slot of the bezel 10 such that each tab engages the corresponding receiving slot when the bezel and side panel are assembled.

In the embodiment described herein, the side panel 21 is formed from a second material different than the first material from which the bezel 10 is formed. The second material may comprise metal, plastic, or composite materials. The second material from which the side panel 21 is formed is more flexible than the first material from which the bezel 10 is formed. In the embodiments shown and described herein, the side panel 21 is formed by injection molding polypropylene. Polypropylene is more flexible than the ABS material from which the bezel 10 is formed. However, it should be understood that other materials and other forming processes can be used to construct the side panel 21. In some embodiments, the side panel 21 is formed as a unitary piece such as when the side panel 21 is injection molded. In other embodiments, the side panels 21 may each comprise multiple pieces. Further, while the side panel 21 is described herein as being formed from a second material different than the first material from which the bezel 10 is formed, it should be understood that the side panel 21 and the bezel 10 can be formed from the same material.

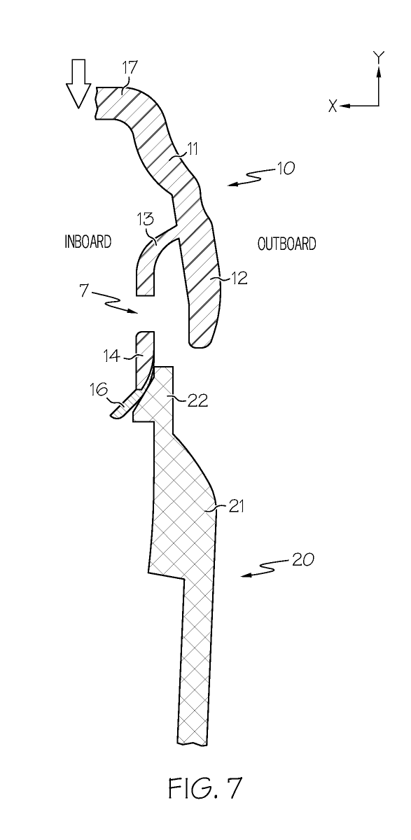

Referring now to FIG. 7, the bezel 10 is assembled to the side panel 21 of the housing 20 by sliding the bezel 10 down onto the side panel 21 so that the bezel 10 and the side panel 21 is mechanically fastened using the tab 22 and receiving slot 7 described hereinabove. Specifically, FIG. 7 shows a partial cross section of the bezel 10 and the side panel 21 when the bezel 10 is in a pre-assembly position over the side panel 21.

During assembly, the bezel 10 is lowered onto the side panel 21 such that the tab 22 of the side panel 21 engages the lead-in portion 16 of the bezel 10. Force is then applied to the bezel 10 to engage the tab 22 of the side panel 21 with the lead-in portion 16 of the bezel 10 such that the lead-in portion 16 of the bezel 10 guides the tab 22 over an outboard side of the snap portion 14 and into engagement with the receiving slot 7 of the bezel 10.

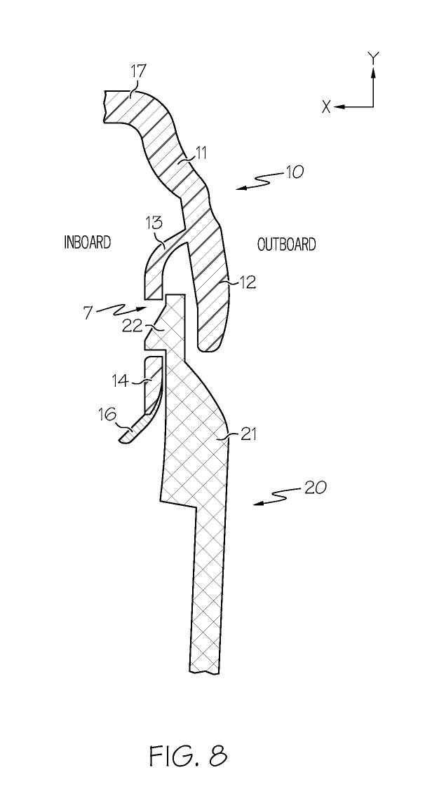

Referring now to FIG. 8, a partial cross section of the bezel 10 assembled onto the side panel 21 is schematically depicted. As shown in FIG. 8, the tab 22 of the side panel 21 is positioned above the snap portion 14 and below the upper engagement portion 13 of the bezel 10 such that the tab 22 engages the receiving slot 7 of the bezel 10. Accordingly, the lead-in portion 16 prevents the bezel 10 from being misaligned on the side panel 21 by guiding the tab 22 of the side panel 21 to the outboard side of the snap portion 14 of the bezel 10 and into alignment with the receiving slot 7 of the bezel 10.

It should now be understood that the bezels for vehicle accessory assemblies described herein prevents a tab of a side panel from being positioned on the wrong side of a snap portion of the bezel when the bezel and the side panel are assembled, thereby increasing the likelihood that when the side panel and the bezel are assembled, the tab will slide to the proper side of the snap portion so that the tab of the side panel engages the receiving slot of the bezel.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A bezel for a vehicle accessory assembly, the bezel comprising:
a body portion;
a perimeter wall extending from an underside of the body portion;
an upper engagement portion extending in an inboard direction from an inboard side of the perimeter wall;
a snap portion coupled to the upper engagement portion, the snap portion comprising a receiving slot for receiving a corresponding tab; and
a lead-in portion extending from the snap portion in an inboard direction such that the lead-in portion is non-coplanar with the snap portion.

2. The bezel of claim 1 wherein the upper engagement portion comprises an upper part and a lower part, wherein, in cross section, the upper part of the upper engagement portion extends from the inboard side of the perimeter wall in a direction substantially perpendicular to the perimeter wall and the lower part of the upper engagement portion extends from the upper part in a direction substantially parallel to the perimeter wall.

3. The bezel of claim 1 wherein the bezel is formed from acrylonitrile butadiene styrene.

4. The bezel of claim 1 wherein an angle between the snap portion and the lead-in portion is in the range of about 125° to about 145°.

5. The bezel of claim 1 wherein an angle between the snap portion and the lead-in portion is about 135°.

6. The bezel of claim 1 further comprising an accessory opening for receiving a corresponding vehicle accessory.

7. The bezel of claim 1 wherein the vehicle accessory assembly is a console.

8. The bezel of claim 1 further comprising an overhang portion extending from the perimeter wall.

9. A vehicle accessory assembly comprising a bezel and a housing wherein:
the bezel comprises:
a body portion;
a perimeter wall extending from an underside of the body portion;
an upper engagement portion extending in an inboard direction from an inboard side of the perimeter wall;
a snap portion coupled to the upper engagement portion, the snap portion comprising a receiving slot for receiving a corresponding tab; and
a lead-in portion extending from the snap portion in an inboard direction such that the lead-in portion is non-coplanar with the snap portion; and
the housing comprises: a side panel having at least one tab extending from a top of the side panel, wherein as the bezel is installed on the housing, the tab of the side panel engages the lead-in portion of the bezel such that the lead-in portion of the bezel guides the tab over an outboard side of the snap portion and into engagement with the receiving slot of the bezel.

10. The vehicle accessory assembly of claim 9 wherein the upper engagement portion of the bezel comprises an upper part and a lower part, wherein, in cross section, the upper part of the upper engagement portion extends from the inboard side of the perimeter wall in a direction substantially perpendicular to the perimeter wall and the lower part of the upper engagement portion extends from the upper part in a direction substantially parallel to the perimeter wall.

11. The vehicle accessory assembly of claim 9 wherein the bezel further comprises an overhang portion extending from the perimeter wall.

12. The vehicle accessory assembly of claim 9 wherein the vehicle accessory assembly is a console.

13. The vehicle accessory assembly of claim 9 wherein the bezel is formed from a first material, the side panel is formed form a second material different than the first material, wherein the second material is more flexible than the first material.

14. The vehicle accessory assembly of claim 9 wherein the bezel is formed from acrylonitrile butadiene styrene and the side panel is formed from polypropylene.

15. The vehicle accessory assembly of claim 9 wherein the bezel further comprises an accessory opening for receiving a corresponding vehicle accessory.

16. The vehicle accessory assembly of claim 9 wherein an angle between the snap portion of the bezel and the lead-in portion of the bezel is in the range of about 125° to about 145°.

17. The vehicle accessory assembly of claim 9 wherein an angle between the snap portion of the bezel and the lead-in portion of the bezel is about 135°.

18. A method of assembling a vehicle accessory assembly comprising:
providing a bezel, the bezel comprising:
a body portion;
a perimeter wall extending from an underside of the body portion;
an upper engagement portion extending in an inboard direction from an inboard side of the perimeter wall;
a snap portion coupled to the upper engagement portion, the snap portion comprising a receiving slot for receiving a corresponding tab; and
a lead-in portion extending from the snap portion in an inboard direction such that the lead-in portion is non-coplanar with the snap portion;
providing a housing comprising a side panel having at least one tab extending from a top of the side panel;
positioning the bezel over the housing;
engaging the tab of the side panel with the lead-in portion of the bezel; and
applying force to the bezel to engage the tab of the side panel with the lead-in portion of the bezel such that the lead-in portion of the bezel guides the tab over an outboard side of the snap portion and into engagement with the receiving slot of the bezel, thereby attaching the bezel to the housing.

19. The method of claim 18 wherein the upper engagement portion of the bezel comprises an upper part and a lower part, wherein, in cross section, the upper part of the upper engagement portion extends from the inboard side of the perimeter wall in a direction substantially perpendicular to the perimeter wall and the lower part of the upper engagement portion extends from the upper part in a direction substantially parallel to the perimeter wall such that when the bezel is installed on the housing, the tab engages the receiving slot of the bezel.

20. The method of claim 18 wherein an angle between the snap portion of the bezel and the lead-in portion of the bezel is in the range of about 125° to about 145°.
